(19) United States
(12) Patent Application Publication
(10) Pub. No.: US 2026/0222559 A1
(43) Pub. Date: Jul. 30, 2026

(54) VIDEO CODING METHOD THAT CONSTRUCTS MOST PROBABLE MODE LIST FOR SIGNALLING OF PREDICTION MODE SELECTED BY INTRA CHROMA PREDICTION AND ASSOCIATED APPARATUS

(71) Applicant: MEDIATEK INC., Hsin-Chu , Taiwan (CN)

(72) Inventors: Cheng-Yen Chuang, Hsinchu City (TW); Chia-Ming Tsai, Hsinchu City (TW); Hsin-Yi Tseng, Hsinchu City (TW); Tzu-Der Chuang, Hsinchu City (TW); Ching-Yeh Chen, Hsinchu City (TW); Chih-Wei Hsu, Hsinchu City (TW); Yi-Wen Chen, San Jose, CA (US)

(73) Assignee: MEDIATEK INC., Hsin-Chu (TW)

(21) Appl. No.: 19/147,318

(22) PCT Filed: Jan. 12, 2024
(86) PCT No.: PCT/CN2024/071948

§ 371 Date: Jul. 10, 2025

Related U.S. Application Data
(60) Provisional application No. 63/479,741, filed on Jan. 13, 2023.
(60) Provisional application No. 63/480,548, filed on Jan. 19, 2023.

(51) Int. Cl. H04N 19/11; H04N 19/176; H04N 19/186

(52) U.S. Cl. CPC H04N 19/11; H04N 19/176; H04N 19/186

(57) ABSTRACT

A method for video coding includes: receiving data to be encoded or decoded as a current block of pixels of a current picture of a video, wherein the current block includes at least one chroma block; and encoding or decoding the current block by a prediction mode for intra chroma prediction of the at least one chroma block, which includes constructing a most probable mode (MPM) list, wherein the MPM list includes one or more intra chroma MPM candidates.

### FIELD

The present invention relates to video coding, and more particularly, to a video coding method that constructs a most probable mode (MPM) list for signalling of a prediction mode selected by intra chroma prediction and an associated apparatus.

### BACKGROUND

The conventional video coding standards generally adopt a block based coding technique to exploit spatial and temporal redundancy. For example, the basic approach is to divide the whole source picture into a plurality of blocks, perform intra/inter prediction on each block, transform residues of each block, and perform quantization and entropy encoding. Besides, a reconstructed picture is generated in a coding loop to provide reference data used for coding following blocks. For certain video coding standards, in-loop filter(s) may be used for enhancing the image quality of the reconstructed frame.

The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, a reconstruction circuit, and in-loop filter(s).

With the help of cross-component prediction (CCP) models, intra chroma prediction becomes more accurate and the prediction distortion of intra chroma mode could be significantly reduced. However, the current syntax design of CCP models is not efficient because many newly proposed CCP modes use a sub-mode syntax design, which will increase the codeword of each CCP mode on average. Thus, there is a need for an innovative syntax design to improve the intra chroma coding efficiency.

### SUMMARY

One of the objectives of the claimed invention is to provide a video coding method that constructs a most probable mode (MPM) list for signalling of a prediction mode selected by intra chroma prediction and an associated apparatus.

According to a first aspect of the present invention, an exemplary method for video coding is disclosed. The exemplary method includes: receiving data to be encoded or decoded as a current block of pixels of a current picture of a video, wherein the current block comprises at least one chroma block; and encoding or decoding the current block by a prediction mode for intra chroma prediction of the at least one chroma block, which includes constructing a most probable mode (MPM) list, wherein the MPM list comprises one or more intra chroma MPM candidates.

According to a second aspect of the present invention, an exemplary video encoder is disclosed. The exemplary video encoder includes a video data memory and an encoding circuit. The video data memory is arranged to receive data to be encoded as a current block of pixels of a current picture of a video, wherein the current block comprises at least one chroma block. The encoding circuit is arranged to perform encoding of the current block by a prediction mode for intra chroma prediction of the at least one chroma block. The encoding circuit includes a most probable mode (MPM) list construction circuit that is arranged to construct an MPM list, wherein the MPM list comprises one or more intra chroma MPM candidates.

According to a third aspect of the present invention, an exemplary video decoder is disclosed. The exemplary video decoder includes a video data memory and a decoding circuit. The video data memory is arranged to receive data to be decoded as a current block of pixels of a current picture of a video, wherein the current block comprises at least one chroma block. The decoding circuit is arranged to perform decoding of the current block by a prediction mode for intra chroma prediction of the at least one chroma block. The decoding circuit includes a most probable mode (MPM) list construction circuit that is arranged to construct an MPM list, wherein the MPM list comprises one or more intra chroma MPM candidates.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating multi-type tree splitting modes according to an embodiment of the present invention.

FIG. 2 is a diagram illustrating splitting flags signalling in quadtree with nested multi-type tree coding tree structure according to an embodiment of the present invention.

FIG. 3 is a diagram illustrating an example of quadtree with nested multi-type tree coding block structure according to an embodiment of the present invention.

FIG. 4 is a diagram illustrating examples of disallowed TT and BT partitioning in VTM according to an embodiment of the present invention.

FIG. 5 is a diagram illustrating 67 intra prediction modes according to an embodiment of the present invention.

FIG. 6 is a diagram illustrating reference samples for wide-angular intra prediction according to an embodiment of the present invention.

FIG. 7 is a diagram illustrating locations of the samples used for the derivation of α and β according to an embodiment of the present invention.

FIG. 8 is a diagram illustrating an example of classifying the neighbouring samples into two groups according to an embodiment of the present invention.

FIG. 9 is a diagram illustrating Illustration of the effect of the slope adjustment parameter “u” according to an embodiment of the present invention.

FIG. 10 is a diagram illustrating spatial part of the convolutional filter according to an embodiment of the present invention.

FIG. 11 is a diagram illustrating reference area (with its paddings) used to derive the filter coefficients according to an embodiment of the present invention.

FIG. 12 is a diagram illustrating 16 gradient patterns for GLM according to an embodiment of the present invention.

FIG. 13 is a diagram illustrating positions of spatial merge candidate according to an embodiment of the present invention.

FIG. 14 is a diagram illustrating candidate pairs considered for redundancy check of spatial merge candidates according to an embodiment of the present invention.

FIG. 15 is a diagram illustrating motion vector scaling for temporal merge candidate according to an embodiment of the present invention.

FIG. 16 is a diagram illustrating candidate positions for temporal merge candidate, C0 and C1, according to an embodiment of the present invention.

FIG. 17 is a diagram illustrating neighboring blocks used to derive the non-adjacent merge candidates according to an embodiment of the present invention.

FIG. 18 is a block diagram illustrating a video encoder that supports the proposed intra chroma MPM list design according to an embodiment of the present invention.

FIG. 19 is a block diagram illustrating a video decoder that supports the proposed intra chroma MPM list design according to an embodiment of the present invention.

FIG. 20 is a flowchart illustrating a video coding method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

### Acronyms

CU: Coding unit
CTB (LCU): Coding tree block (largest coding unit)
HEVC: High Efficiency Video Coding
VVC: Versatile Video Coding
MC: Motion compensation
MV: Motion vector
DF: Deblocking filter
T/IT: Transform/Inverse transform
Q/IQ: Quantization/Inverse quantization
SAO: Sample adaptive offset
ALF: Adaptive loop filter
QTBT: Quad-tree plus binary tree
QT: Quad-tree
BT: Binary-tree
TT: Ternary-tree
SPS: Sequence parameter set
PPS: Picture parameter set
APS: Adaptation Parameter Set
PH: Picture Header
SH: Slice header

### 1. Introduction

### 1.1 Partitioning of the CTUs Using a Tree Structure

In HEVC, a CTU is split into CUs by using a quaternary-tree structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

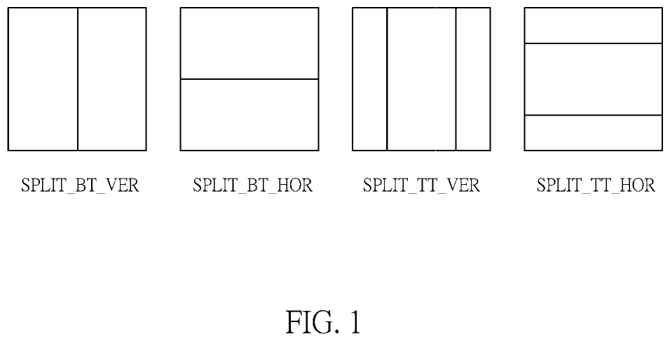

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 1, there are four splitting types in multi-type tree structure, vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

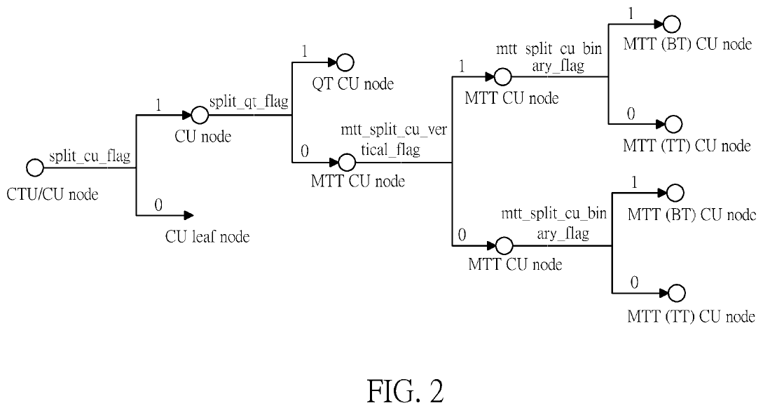

FIG. 2 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1-1.

TABLE 1-1
MttSplitMode derviation based on multi-type tree syntax elements

| | mtt_split_cu_vertical_{—} | mtt_split_cu_binary_{—} |
|---|---|---|
| MttSplitMode | flag | flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

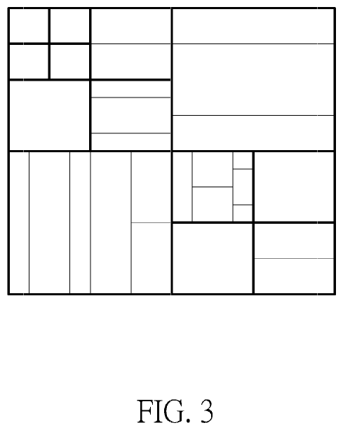

FIG. 3 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### 1.2 Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

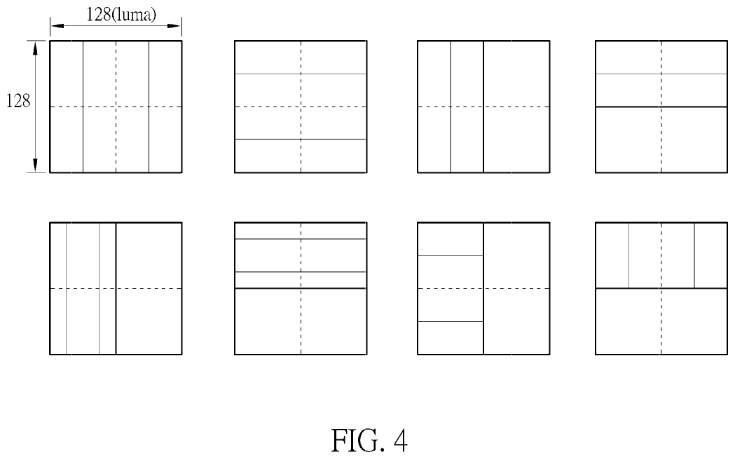

In order to keep the VPDU size as 64×64 luma samples, the following normative partition restrictions (with syntax signaling modification) are applied in VTM, as shown in FIG. 4:
TT split is not allowed for a CU with either width or height, or both width and height equal to 128.
For a 128×N CU with N≤64 (i.e., width equal to 128 and height smaller than 128), horizontal BT is not allowed.
For an N×128 CU with N≤64 (i.e., height equal to 128 and width smaller than 128), vertical BT is not allowed.

### 1.3 Intra Chroma Partitioning and Prediction Restriction

In typical hardware video encoders and decoders, processing throughput drops when a picture has smaller intra blocks because of sample processing data dependency between neighbouring intra blocks. The predictor generation of an intra block requires top and left boundary reconstructed samples from neighbouring blocks. Therefore, intra prediction has to be sequentially processed block by block.

In HEVC, the smallest intra CU is 8×8 luma samples. The luma component of the smallest intra CU can be further split into four 4×4 luma intra prediction units (PUs), but the chroma components of the smallest intra CU cannot be further split. Therefore, the worst case hardware processing throughput occurs when 4×4 chroma intra blocks or 4×4 luma intra blocks are processed. In VVC, in order to improve worst case throughput, chroma intra CBs smaller than 16 chroma samples (size 2×2, 4×2, and 2×4) and chroma intra CBs with width smaller than 4 chroma samples (size 2×N) are disallowed by constraining the partitioning of chroma intra CBs.

In single coding tree, a smallest chroma intra prediction unit (SCIPU) is defined as a coding tree node whose chroma block size is larger than or equal to 16 chroma samples and has at least one child luma block smaller than 64 luma samples, or a coding tree node whose chroma block size is not 2×N and has at least one child luma block 4×N luma samples. It is required that in each SCIPU, all CBs are inter, or all CBs are non-inter, i.e., either intra or intra block copy (IBC). In case of a non-inter SCIPU, it is further required that chroma of the non-inter SCIPU shall not be further split and luma of the SCIPU is allowed to be further split. In this way, the small chroma intra CBs with size less than 16 chroma samples or with size 2×N are removed. In addition, chroma scaling is not applied in case of a non-inter SCIPU. Here, no additional syntax is signalled, and whether a SCIPU is non-inter can be derived by the prediction mode of the first luma CB in the SCIPU. The type of a SCIPU is inferred to be non-inter if the current slice is an I-slice or the current SCIPU has a 4×4 luma partition in it after further split one time (because no inter 4×4 is allowed in VVC); otherwise, the type of the SCIPU (inter or non-inter) is indicated by one flag before parsing the CUs in the SCIPU.

For the dual tree in intra picture, the 2×N intra chroma blocks are removed by disabling vertical binary and vertical ternary splits for 4×N and 8×N chroma partitions, respectively. The small chroma blocks with size 2×2, 4×2, and 2×4 are also removed by partitioning restrictions.

In addition, a restriction on picture size is considered to avoid 2×2/2×4/4×2/2×N intra chroma blocks at the corner of pictures by considering the picture width and height to be multiple of max (8, MinCbSizeY).

1.4 Intra Mode Coding with 67 Intra Prediction Modes

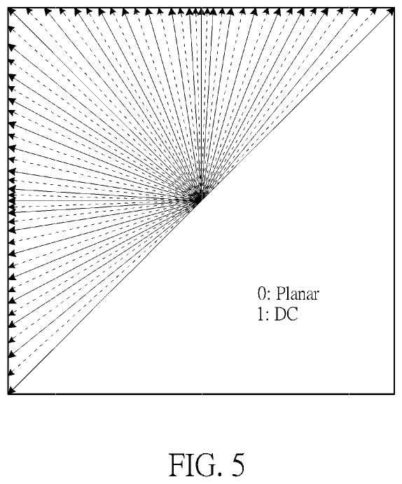

To capture the arbitrary edge directions presented in natural video, the number of directional intra modes in VVC is extended from 33, as used in HEVC, to 65. The new directional modes not in HEVC are depicted as dotted arrows in FIG. 5, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 1.5 Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
MPM list→{Planar, DC, V, H, V−4, V+4}
If one of modes Left and Above is angular mode, and the other is non-angular:
Set a mode Max as the larger mode in Left and Above
MPM list→{Planar, Max, Max−1, Max+1, Max −2, Max+2}
If Left and Above are both angular and they are different:
Set a mode Max as the larger mode in Left and Above
Set a mode Min as the smaller mode in Left and Above
If Max−Min is equal to 1:
MPM list→{Planar, Left, Above, Min−1, Max+1, Min−2}
Otherwise, if Max−Min is greater than or equal to 62:
MPM list→{Planar, Left, Above, Min+1, Max−1, Min+2}
Otherwise, if Max−Min is equal to 2:
MPM list→{Planar, Left, Above, Min+1, Min−1, Max+1}
Otherwise:
MPM list→{Planar, Left, Above, Min−1, Min+1, Max−1}
If Left and Above are both angular and they are the same:
MPM list→{Planar, Left, Left−1, Left+1, Left −2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### 1.6 Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

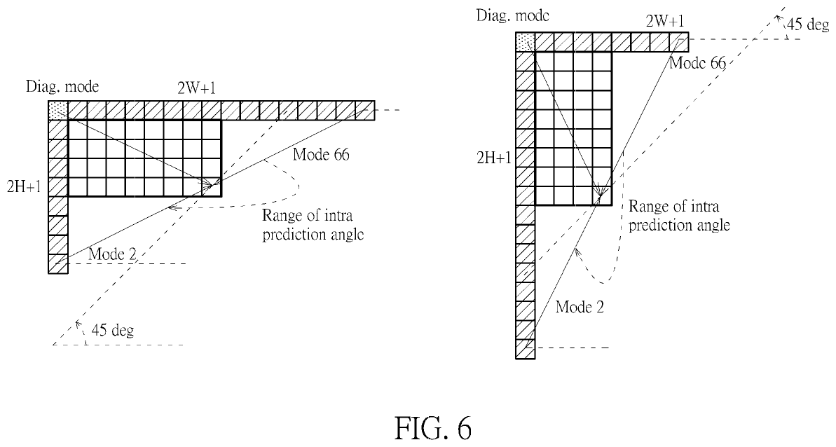

To support these prediction directions, the top reference with length 2W+1, and the left reference with length 2H+1, are defined as shown in FIG. 6.

The number of replaced modes in wide-angular direction mode depends on the aspect ratio of a block. The replaced intra prediction modes are illustrated in Table 1-2.

TABLE 1-2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2 chroma format is updated by replacing some values of the entries of the mapping table to convert prediction angle more precisely for chroma blocks.

### 1.7 Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(I,j) represents the predicted chroma samples in a CU and rec_{L}(I,j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when CCLM_LT mode is applied;
W′=W+H when CCLM_T mode is applied;
H′=H+W when CCLM_L mode is applied;

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when CCLM_LT mode is applied and both above and left neighbouring samples are available;
S[W′/8, −1], S[3*W′/8, −1],S[5*W′/8, −1],S[7*W′/8, −1] when CCLM_T mode is applied or only the above neighbouring samples are available;
S[−1, H′/8], S[−1, 3*H′/8], S[−1, 5*H′/8], S[−1, 7*H′/8] when CCLM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and X¹_{B}. Their corresponding chroma sample values are denoted as y⁰_{A}, y¹_{A}, y¹_{B} and y¹_{B}. Then Xₐ, X_{b}, Yₐ and Y_{b} are derived as:

$${X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1 ; {Y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1 \qquad ( 2 )$$

Finally, the linear model parameters α and β are obtained according to the following equations.

$$α = \frac{{Y}_{a} - {Y}_{b}}{{x}_{a} - {x}_{b}} \qquad ( 3 )$$

$$β = {Y}_{b} - α \cdot {X}_{b} \qquad ( 4 )$$

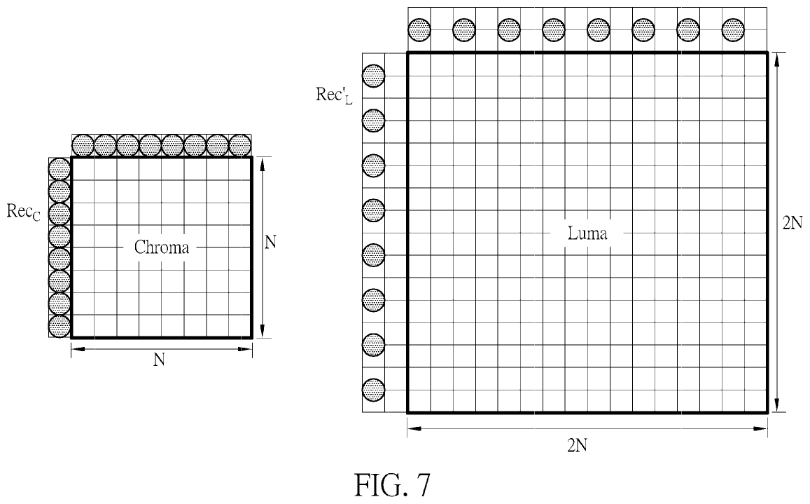

FIG. 7 shows an example of the location of the left and above samples and the sample of the current block involved in the CCLM_LT mode.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables

Besides the above template and left template can be used to calculate the linear model coefficients together, they also can be used alternatively in the other 2 LM modes, called CCLM_T, and CCLM_L modes.

In CCLM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In CCLM_LT mode, left and above templates are used to calculate the linear model coefficients.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsampling filters are as follows, which are corresponding to “type-0” and “type-2” content, respectively.

$${Rec}_{L}^{′} ( i , j ) = \\ [ \begin{matrix}{rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] ≫ 3 \qquad ( 6 )$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j - 1 ) + \\ {rec}_{L} ( 2 i - 1 , 2 j ) + {rec}_{L} ( 2 i , 2 j + 1 ) + 4\end{matrix} ] ≫ 3 \qquad ( 7 )$$

Note that only one luma line (general line buffer in intra prediction) is used to make the downsampled luma samples when the upper reference line is at the CTU boundary. This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (CCLM_LT, CCLM_A, and CCLM_L). Chroma mode signalling and derivation process are shown in Table 1-3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1-3
Derivation of chroma prediction mode
from luma mode when CCLM is enabled

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 1-4.

TABLE 1-4
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 1-4, the first bin indicates whether it is regular (0) or CCLM modes (1). If it is CCLM mode, then the next bin indicates whether it is CCLM_LT (0) or not. If it is not CCLM_LT, next 1 bin indicates whether it is CCLM_L (0) or CCLM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 1-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 1.7.1 Multiple Model CCLM

In the JEM, multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples. Three MMLM model modes (MMLM_LT, MMLM_T, and MMLM_L) are allowed for choosing the neighbouring samples from left-side and above-side, above-side only, and left-side only, respectively.

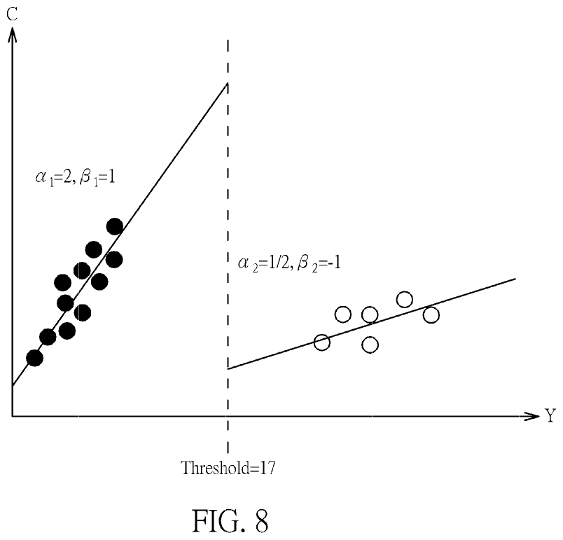

FIG. 8 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ v , y ] = {α}_{1} \times {Rec}_{L}^{′} [ x , y ] + {β}_{1} if {Rec}_{L}^{′} [ x , y ] \leq Threshold \\ {Pred}_{C} [ v , y ] = {α}_{2} \times {Rec}_{L}^{′} [ x , y ] + {β}_{2} if {Rec}_{L}^{′} [ x , y ] > Threshold\end{matrix} \qquad ( 8 )$$

### 1.7.2 Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = a ’ * lumaVal + b ’$$

$$where$$

$$\begin{matrix}a ’ = a + u \\ b ’ = b - u * {y}_{r} .\end{matrix}$$

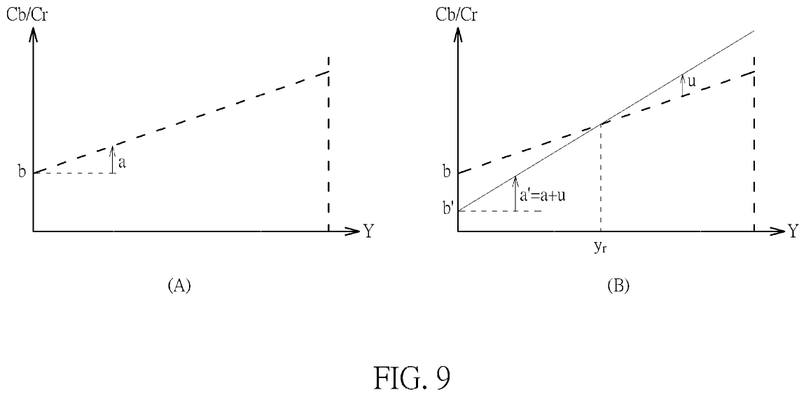

With this selection the mapping function is tilted or rotated around the point with luminance value yᵣ. The average of the reference luma samples used in the model creation as yᵣ in order to provide a meaningful modification to the model. FIG. 9 illustrates the process, where the sub-diagram (A) illustrated a model created with the current CCLM, and the sub-diagram (B) illustrates a model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 1.8 Local Illumination Compensation (LIC)

Local Illumination Compensation (LIC) is a method to do inter predict by using neighbor samples of current block and reference block. It is based on a linear model using a scaling factor a and an offset b. It derives a scaling factor a and an offset b by referring to the neighbor samples of current block and reference block. Moreover, it's enabled or disabled adaptively for each CU.

For more detail for LIC, it can refer to the document “JVET-C1001, title: Algorithm Description of Joint Exploration Test Model 3”.

### 1.9 Convolutional Cross-Component Model (CCCM)

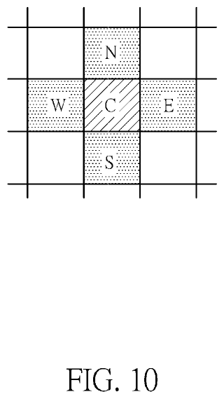

In CCCM, a convolutional model is applied to improve the chroma prediction performance. The convolutional model has 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 10.

The nonlinear term (denoted as P) is represented as power of two of the center luma sample C and scaled to the sample value range of the content:

$$P = ( C * C + midVal ) ≫ bitDepth$$

That is, for 10-bit content it is calculated as:

$$P = ( C * C + 5 \; 12 ) ≫ 10$$

The bias term (denoted as B) represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

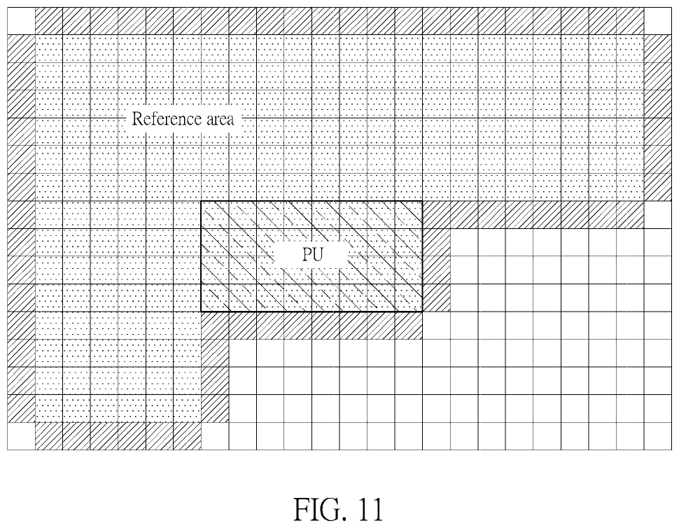

The filter coefficients ci are calculated by minimising MSE between predicted and reconstructed chroma samples in the reference area. FIG. 11 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### 1.10 Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

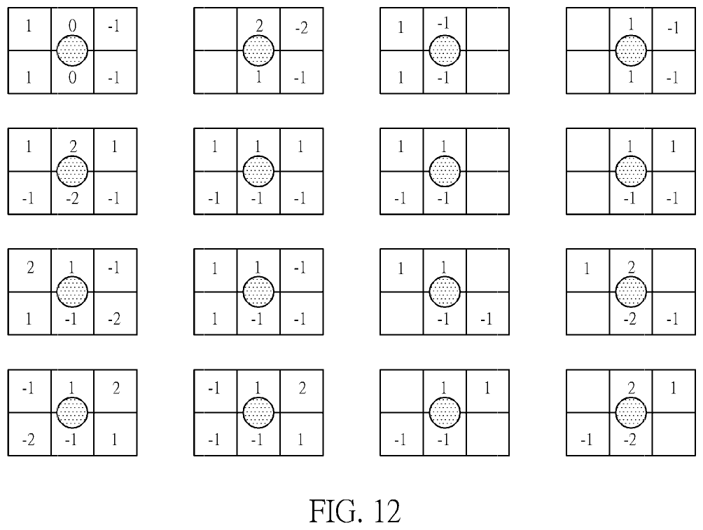

For signaling, when the CCLM mode is enabled to the current CU, two flags are signaled separately for Cb and Cr components to indicate whether GLM is enabled to each component; if the GLM is enabled for one component, one syntax element is further signaled to select one of 16 gradient filters illustrated in FIG. 12 for the gradient calculation. The GLM can be combined with the existing CCLM by signaling one extra flag in bitstream. When such combination is applied, the filter coefficients that are used to derive the input luma samples of the linear model is calculated as the combination of the selected gradient filter of the GLM and the down-sampling filter of the CCLM.

### 1.11 Spatial Candidates Derivation

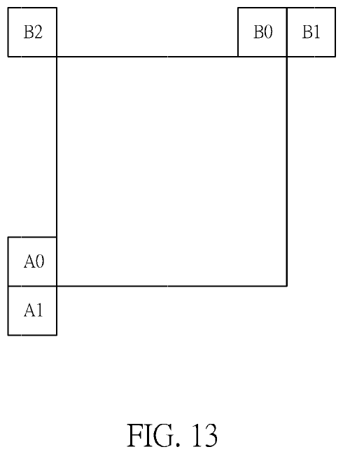

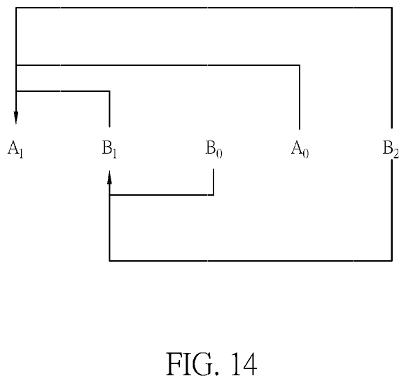

The derivation of spatial merge candidates in VVC is same to that in HEVC except the positions of first two merge candidates are swapped. A maximum of four merge candidates are selected among candidates located in the positions depicted in FIG. 13. The order of derivation is B₀, A₀, B₁, A₁ and B₂. Position B₂ is considered only when one or more than one CUs of position B₀, A₀, B₁, A₁ are not available (e.g., because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 14 are considered and a candidate is only added to the list if the corresponding candidate used for redundancy check has not the same motion information.

### 1.12 Temporal Candidates Derivation

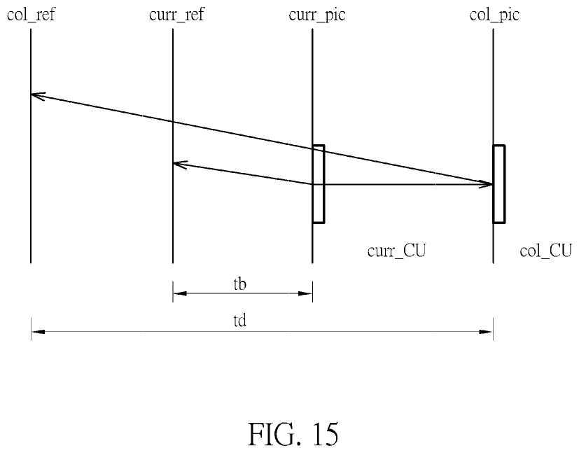

In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the dotted line in FIG. 15, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

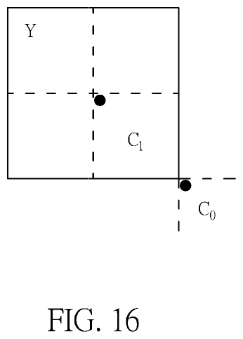

The position for the temporal candidate is selected between candidates C₀ and C₁, as depicted in FIG. 16. If CU at position C₀ is not available, is intra coded, or is outside of the current row of CTUs, position C₁ is used. Otherwise, position C₀ is used in the derivation of the temporal merge candidate.

### 1.13 Non-Adjacent Spatial Candidate

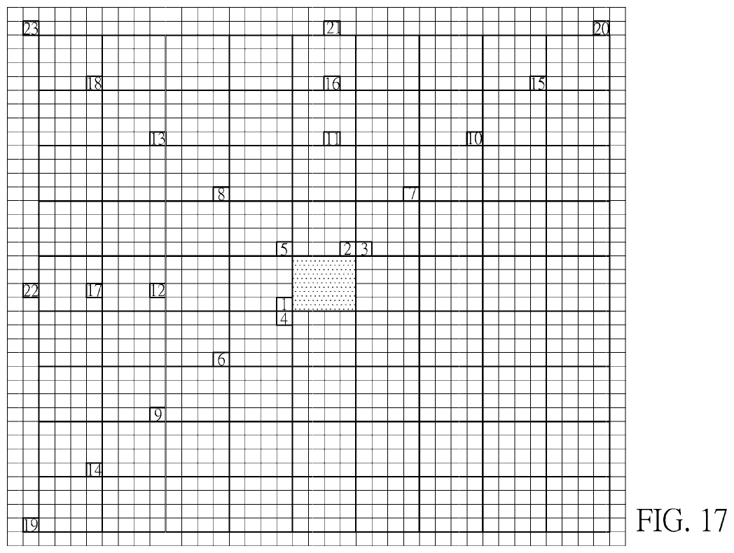

The non-adjacent spatial merge candidates as in JVET-L0399 are inserted after the TMVP in the regular merge candidate list. The pattern of spatial merge candidates is shown in FIG. 17. The distances between non-adjacent spatial candidates and current coding block are based on the width and height of current coding block. The line buffer restriction is not applied.

### 2. Proposed Method

In ECM, many methods of cross-component prediction (CCP) are proposed to improve the intra chroma coding efficiency. For example,
CCLM_L, CCLM_T, CCLM_LT, MMLM_L, MMLM_T, MMLM_LT
CCCM_L, CCCM_T, CCCM_LT, MMCCCM_L, MMCCCM_T, MMCCCM_LT
GLM_L, GLM_T, GLM_LT, MMGLM_L, MMGLM_T, MMGLM_LT
GLM2_L, GLM2_T, GLM2_LT, MMGLM2_L, MMGLM2_T, MMGLM2_LT (GLM2 is the GLM with the corresponding luma term)
For each GLM mode, 4 gradient kernels could be selected.

With the help of these cross-component models, intra chroma prediction becomes more accurate and the prediction distortion of intra chroma mode could be significantly improved. However, current syntax design of CCP models is not efficient because many newly proposed CCP modes use a sub-mode syntax design which will increase the codeword of each CCP mode on average.

As a result, this disclosure proposes to introduce an MPM-like syntax shortcut design to improve the intra coding efficiency.

In one embodiment, the proposed MPM design could be applied to all intra chroma modes or a subset of all intra chroma modes. In another embodiment, the proposed MPM design could be applied to all CCP modes or a subset of all CCP modes.

### 2.1 MPM Syntax Design

In one embodiment, all intra chroma modes or a subset of all intra chroma modes could be put into the MPM list. In another embodiment, only a fixed number of prediction modes could be put into the MPM list, and this fixed number could be a pre-defined value. In another embodiment, only the first number of prediction modes could be put into the MPM list, and the first number could be selected from a pre-defined lookup table according to current block size or the selected intra luma mode.

In one embodiment, an intra chroma_mpm_flag could be signaled to indicate whether the selected prediction mode exists in the MPM list or not.

In one embodiment, if the intra_chroma_mpm_flag is true, an intra_chroma_mpm_index could be further signaled to indicate the MPM index, and the MPM index could be coded by a truncated unary method, a truncated binary method or a mixed method of truncated unary and truncated binary.

In one embodiment, if the intra_chroma_mpm_flag is false, which means the prediction modes do not exist in the MPM list, a remaining mode index could be signaled, and it could be coded by equal bin method or truncated binary method.

In one embodiment, the proposed MPM syntax design could co-exist with other inheritance-based coding tools (e.g., cross-component model (CCM) merge mode).

### 2.2 MPM List Construction

In one embodiment, the MPM list construction method could be similar to intra luma MPM. The prediction mode of a previously coded block at the neighboring region of current block could be added into MPM list.

In one embodiment, a previously coded block at the above pre-defined position and a previously coded block at the left pre-defined position will be checked and then put into MPM list. In another embodiment, multiple previously coded blocks at the neighboring pre-defined position will be checked and then put into MPM list. In another embodiment, multiple previously coded blocks at the neighboring pre-defined position and multiple previously coded blocks at the non-adjacent pre-defined position will be checked and then put into MPM list.

In another embodiment, in addition to insert the prediction mode P of neighboring coded block to MPM list, prediction mode similar to P could also be one of the candidates to join the MPM list. The definition of similar mode could be using the same template region, using the same cross-component model, or using the input sample from same domain (e.g., downsampled domain, non-downsampled domain, or gradient domain).

In one embodiment, the prediction modes of all neighboring coded blocks could be added into MPM list first, and then the similar prediction modes of all neighboring coded blocks could be added into MPM later. In another embodiment, after adding one prediction mode P of certain neighboring coded block into MPM list, prediction modes similar to P could be added into MPM list.

In one embodiment, the inserting order of MPM list could be a pre-defined order. In another embodiment, the inserting order of MPM list could depend on the block shape. For example, if the block height is larger than the block width, insert the prediction mode from the left side first. Otherwise, insert the prediction mode from the above side first.

In another embodiment, the inserting order of MPM list could depend on the prediction mode. For example, we could always insert the CCCM mode first. For another example, we could always insert the GLM mode first.

In another embodiment, a voting method similar to DIMD could be used in the MPM list construction. By checking the coded mode at several pre-defined positions and then counting the number of occurrences of each mode, the MPM list could be built by selecting several most frequently used modes.

In another embodiment, a template matching (TM) method similar to TIMD could be used in the MPM list construction. By generating the prediction of each mode on the neighboring template region and then calculating the SAD or SATD cost of each mode, the MPM list could be built by selecting several modes with smallest TM cost.

In another embodiment, the inserting order of MPM list could be a mixed method from the above mentioned method.

### 2.3 MPM List Similarity Check

In one embodiment, only if a mode is similar to the other mode already in MPM list, it can be added into MPM list.

In one embodiment, if a mode is similar to the other mode already in MPM list, it cannot be added into MPM list.

In one embodiment, two modes could be the similar if they are the same model type (e.g., CCLM, CCCM, GLM . . . ). In another embodiment, two modes could be the similar if they use the same template region for deriving their parameters. In another embodiment, two modes could be the similar if the input sample they used are from the same domain (e.g., downsampled luma domain, non-downsampled luma domain or gradient domain). In another embodiment, the definition of similarity could be the combination of above mentioned.

### 2.4 High-Level Syntax Control

In one embodiment, a high-level syntax could be signaled for enabling the intra chroma MPM design. The high-level syntax sps_chroma_mpm_flag could be signaled in sps, or the high-level syntax pps_chroma_mpm_flag could be signaled in pps.

In one embodiment, a high-level syntax could be signaled for indicating the size of MPM list. The high-level syntax sps_chroma_mpm_size could be signaled in sps, or the high-level syntax pps_chroma_mpm_size could be signaled in pps.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

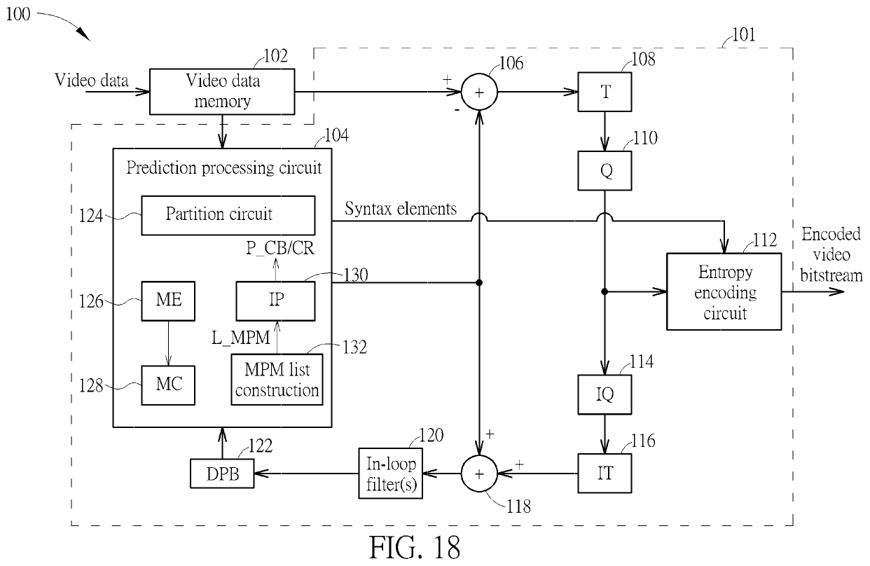

FIG. 18 is a block diagram illustrating a video encoder that supports the proposed intra chroma MPM list design according to an embodiment of the present invention. By way of example, but not limitation, the video encoder 100 may be a VVC encoder. The video encoder 100 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. The proposed intra chroma MPM list design can be referenced for signalling a prediction mode selected by intra chroma prediction applied to a chroma block.

As shown in FIG. 18, the video encoder 100 includes an encoding circuit 101 and a video data memory 102. The encoding circuit 101 may include a prediction processing circuit 104, a residual generation circuit 106, a transform circuit (labeled by “T”) 108, a quantization circuit (labeled by “Q”) 110, an entropy encoding circuit (e.g., a variable-length code (VLC) encoder) 112, an inverse transform circuit (labeled by “IQ”) 114, an inverse transform circuit (labeled by “IT”) 116, a reconstruction circuit 118, one or more in-loop filters 120, and a decoded picture buffer (DPB) 122. It should be noted that the encoder architecture shown in FIG. 18 is for illustrative purposes only, and is not meant to be a limitation of the present invention. In practice, any video encoder using/supporting the proposed MPM-like syntax design used for signalling of intra chroma prediction mode falls within the scope of the present invention.

In this embodiment, the video data memory 102 is arranged to receive data to be encoded as a current block of pixels of a current picture of a video, wherein the current block includes at least one chroma block. The encoding circuit 101 is arranged to perform encoding of the current block by a prediction mode for intra chroma prediction of the chroma block. The prediction processing circuit 104 may include a partition circuit 124, a motion estimation circuit (labeled by “ME”) 126, a motion compensation circuit (labeled by “MC”) 128, an intra prediction circuit (labeled by “IP”) 130, and an MPM list construction circuit (labeled by “MPM list construction”) 132. The proposed MPM-like syntax design is supported by the prediction processing circuit 104 (particularly, intra prediction circuit 130 of prediction processing circuit 104). As the present invention is focused on the proposed intra chroma MPM list design used for signalling of intra chroma prediction mode and a person skilled in the art should readily understand details of other circuit components included in the video encoder 100, further description of principles of other circuit components included in the video encoder 100 is omitted here for brevity.

The prediction processing circuit 104 performs an intra chroma prediction method for determining a prediction mode of a chroma block. Specifically, the MPM list construction circuit 132 is arranged to construct an ordered MPM list of one or more intra chroma MPM candidates (called “intra chroma MPM list L_MPM” hereinafter) for a chroma block (e.g., a Cr block or a Cb block) included in a coding unit, and the intra prediction circuit 130 is arranged to determine a prediction mode of the chroma block, and generate an intra predictor P_CB/CR of each chroma sample included in the chroma block according to the prediction mode of the chroma block. In one embodiment, the proposed intra chroma MPM list design can be applied to all intra chroma modes or a subset of all intra chroma modes. That is, the intra chroma MPM list L_MPM can include all intra chroma modes or a subset of all intra chroma modes. In another embodiment, the proposed intra chroma MPM list design can be applied to all CCP modes or a subset of all CCP modes. That is, the intra chroma MPM list L_MPM can include all CCP modes (e.g., MMLM, GLM, CCCM, GL-CCCM, NoSubCCCM, CCCM-MDF, BVG-CCCM, and CCMerge) or a subset of all CCP modes. In another embodiment, only a fixed number of prediction modes can be put into the intra chroma MPM list L_MPM. That is, a size of the intra chroma MPM list L_MPM may be set by a pre-defined value.

In some embodiments of the present invention, after the prediction mode of the chroma block is determined by the intra prediction circuit 130, the intra prediction circuit 130 sets and outputs syntax elements indicative of information of the selected prediction mode to the entropy encoding circuit 112, such that the syntax elements indicative of information of the selected prediction mode are encoded into the encoded video bitstream output from the video encoder 100. In one embodiment, the syntax elements may include an intra_chroma_mpm_flag that is signalled to indicate whether the prediction mode is included in the intra chroma MPM list L_MPM. In one embodiment, if the intra_chroma_mpm_flag is true (e.g., intra_chroma_mpm_flag=1), the syntax elements may include an intra_chroma_mpm_index that is signalled to indicate selection of the prediction mode (which is included in the intra chroma MPM list L_MPM). In one embodiment, if the intra_chroma_mpm_flag is false (e.g., intra_chroma_mpm_flag=0), the syntax elements may include a remaining mode index that is signalled to indicate selection of the prediction mode (which is not included in the intra chroma MPM list L_MPM).

Regarding construction of the intra chroma MPM list L_MPM, it may employ a manner similar to that employed by construction of an intra luma MPM list. Hence, the prediction mode of a preciously coded block (i.e., a precious chroma block that is encoded before the current chroma block) at the neighboring region of the current chroma block can be added to the intra chroma MPM list L_MPM. In one embodiment, a prediction mode of one previously coded block at an above pre-defined position and a prediction mode of another previously coded block at a left pre-defined position will be checked and then put into the intra chroma MPM list L_MPM. In another embodiment, prediction modes of multiple previously coded blocks at neighboring pre-defined positions will be checked and then put into the intra chroma MPM list L_MPM. In another embodiment, prediction modes of multiple previously coded blocks at non-adjacent pre-defined positions will be checked and then put into the intra chroma MPM list L_MPM.

In addition to inserting a first prediction mode P1 to the intra chroma MPM list L_MPM, the MPM list construction circuit 132 may further insert a second prediction mode P2 to the intra chroma MPM list L_MPM according to the first prediction mode P1 already included in the intra chroma MPM list L_MPM. For example, the MPM list construction circuit 132 may refer to a similarity criterion to check similarity between the first prediction mode P1 and the second prediction mode P2. In one embodiment, only if a prediction mode is similar to the other prediction mode already in the intra chroma MPM list L_MPM, it can be added to the intra chroma MPM list L_MPM. Hence, when the first prediction mode P1 and the second prediction mode P2 are similar modes that meet the similarity criterion, the MPM list construction circuit 132 further adds the second prediction mode P2 (which is similar to the first prediction mode P1) to the intra chroma MPM list L_MPM. In another embodiment, if a prediction mode is similar to the other prediction mode already in the intra chroma MPM list L_MPM, it cannot be added to the intra chroma MPM list L_MPM for increasing the mode diversity of the intra chroma MPM list L_MPM. Hence, when the first prediction mode P1 and the second prediction mode P2 are not similar modes that meet the similarity criterion, the MPM list construction circuit 132 further adds the second prediction mode P2 (which is not similar to the first prediction mode P1) to the intra chroma MPM list L_MPM.

As mentioned above, the similarity criterion is checked to determine whether a prediction mode is a similar mode. In one embodiment, the similarity criterion is defined by two prediction modes using the same template region for deriving their parameters. For example, CCLM_L and CCCM_L may be regarded as similar modes due to using the left template for deriving their model parameters. In another embodiment, the similarity criterion is defined by two prediction modes using the same cross-component model. For example, CCCM_L and CCCM_T may be regarded as similar modes due to having the same model type. In another embodiment, the similarity criterion is defined by two prediction modes using input samples obtained from the same domain (e.g., downsampled luma domain, non-downsampled luma domain, or gradient domain). In another embodiment, the similarity criterion is defined by a combination of above-mentioned rules.

Consider a case where the MPM list construction circuit 132 needs to add prediction modes and their similar prediction modes to the intra chroma MPM list L_MPM. In one embodiment, prediction modes of all neighboring coded blocks can be added to the intra chroma MPM list L_MPM first, and similar prediction modes of all neighboring coded blocks can be added to the intra chroma MPM list L_MPM later. For example, in addition to inserting a first prediction mode P1 and a third prediction mode P3 to the intra chroma MPM list L_MPM, the MPM list construction circuit 132 may further insert a second prediction mode P2 and a fourth prediction mode P4 to the intra chroma MPM list L_MPM according to the first prediction mode P1 and the third prediction mode P3 already included in the intra chroma MPM list L_MPM, where the first prediction mode P1 and the second prediction mode P2 are similar modes that meet the similarity criterion, the third prediction mode P3 and the fourth prediction mode P4 are similar modes that meet the similarity criterion, and an order of any of the first prediction mode P1 and the third prediction mode P3 in the intra chroma MPM list is higher than an order of any of the second prediction mode P2 and the fourth prediction mode P4 in the intra chroma MPM list L_MPM. Assuming that the first prediction mode P1 is Left, the third prediction mode is Above, the second prediction mode is Left_similar, and the fourth prediction mode is Above_similar, the prediction modes in the intra chroma MPM list L_MPM may have an order of Left→Above→Left_similar→Above_similar.

In another embodiment, after adding one prediction mode of certain neighboring coded block into the intra chroma MPM list L_MPM, the MPM list construction circuit 132 adds one similar prediction to the intra chroma MPM list L_MPM. For example, in addition to inserting a first prediction mode P1 and a third prediction mode P3 to the intra chroma MPM list L_MPM, the MPM list construction circuit 132 may further insert a second prediction mode P2 and a fourth prediction mode P4 to the intra chroma MPM list L_MPM according to the first prediction mode P1 and the third prediction mode P3 already included in the intra chroma MPM list L_MPM, where the first prediction mode P1 and the second prediction mode P2 are similar modes that meet the similarity criterion, the third prediction mode P3 and the fourth prediction mode P4 are similar modes that meet the similarity criterion, and an order of any of the first prediction mode P1 and the second prediction mode P2 in the intra chroma MPM list L_MPM is higher than an order of any of the third prediction mode P3 and the fourth prediction mode P4 in the intra chroma MPM list L_MPM. Assuming that the first prediction mode P1 is Left, the third prediction mode is Above, the second prediction mode is Left similar, and the fourth prediction mode is Above_similar, the prediction modes in the intra chroma MPM list L_MPM may have an order of Left→Left_similar→Above→Above_similar.

The MPM list construction circuit 132 may construct the intra chroma MPM list L_MPM by adding prediction modes to the intra chroma MPM list L_MPM according to an inserting order. In one embodiment, the MPM list construction circuit 132 sets the inserting order of prediction modes in the intra chroma MPM list L_MPM by a pre-defined inserting order. In another embodiment, the MPM list construction circuit 132 sets the inserting order of prediction modes in the intra chroma MPM list L_MPM according to a block shape of the chroma block. For example, if the block height is larger than the block width, the prediction mode from the left side is added first, and the prediction mode from the above side is added later. For another example, if the block width is larger than the block height, the prediction mode from the above side is added first, and the prediction mode from the left side is added later. In another embodiment, the MPM list construction circuit 132 sets the inserting order of prediction modes in the intra chroma MPM list L_MPM according to prediction mode priority, where a more powerful prediction mode is added first, and a less powerful prediction mode is added later. For example, the CCCM mode is always added first. For another example, the GLM mode is always added first.

In some embodiments of the present invention, a voting method similar to DIMD can be used in the MPM list construction. For example, the MPM list construction circuit 132 counts occurrence frequency of prediction mode candidates by checking prediction modes of multiple previously coded blocks at pre-defined positions, and adds selected prediction modes to the intra chroma MPM list L_MPM according to the occurrence frequency of the prediction mode candidates, wherein the selected prediction modes are several most frequently used prediction modes selected from the prediction mode candidates.

In some embodiments of the present invention, a template matching (TM) method similar to TIMD can be used in the MPM list construction. For example, the MPM list construction circuit 132 performs prediction on reference samples of a neighboring template according to each of prediction mode candidates, calculates a TM cost for each of the prediction mode candidates, and adds selected prediction modes to the intra chroma MPM list L_MPM according to TM costs of the prediction mode candidates, wherein the selected prediction modes are several prediction modes with smallest TM costs that are selected from the prediction mode candidates.

In another embodiment, the inserting order of prediction modes in the intra chroma MPM list L_MPM is set by a combination of above-mentioned methods.

As mentioned above, the intra prediction circuit 130 may set and output syntax elements to the entropy encoding circuit 112, such that the syntax elements are signalled from the video encoder to the video decoder via the encoded video bitstream. In one embodiment, a high-level syntax element can be signalled for enabling the intra chroma MPM list design. For example, a high-level syntax element sps_chroma_mpm_flag (which is included in a sequence parameter set (SPS)) or pps_chroma_mpm_flag (which is included in a picture parameter set (PPS)) is signalled to indicate to apply the intra chroma prediction method with construction of the intra chroma MPM list. In another embodiment, a high-level syntax element can be signalled for indicating the size of the MPM list. For example, a high-level syntax element sps_chroma_mpm_size (which is included in SPS) or pps_chroma_mpm_size (which is included in PPS) is signalled to indicate the size of the intra chroma MPM list L_MPM.

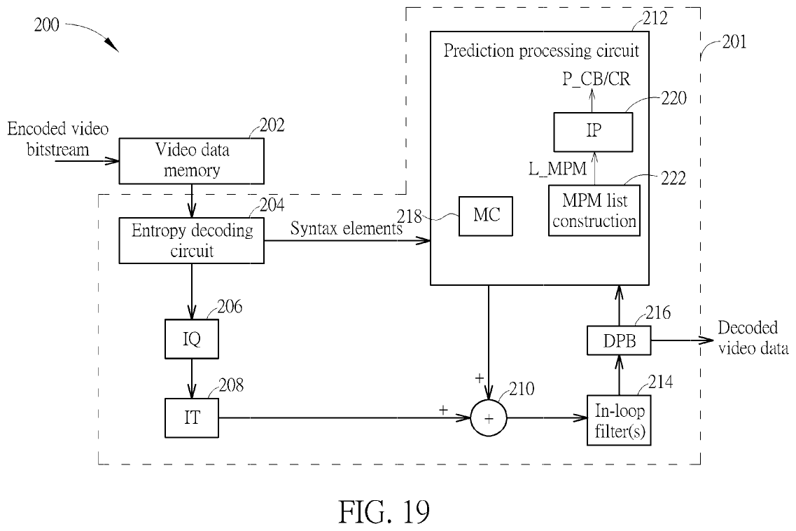

FIG. 19 is a block diagram illustrating a video decoder that supports the proposed intra chroma MPM list design according to an embodiment of the present invention. By way of example, but not limitation, the video decoder 200 may be a VVC decoder. The video decoder 200 includes a decoding circuit 201 and a video data memory 202. The decoding circuit 201 may include an entropy decoding circuit (e.g., a VLC decoder) 204, an inverse quantization circuit (labeled by “IQ”) 206, an inverse transform circuit (labeled by “IT”) 208, a reconstruction circuit 210, a prediction processing circuit 212, one or more in-loop filters 214, and a decoded picture buffer (DPB) 216. It should be noted that the decoder architecture shown in FIG. 19 is for illustrative purposes only, and is not meant to be a limitation of the present invention. In practice, any video decoder using/supporting the proposed MPM-like syntax design falls within the scope of the present invention.

The video data memory 202 is arranged to receive data to be decoded as a current block of pixels of a current picture of a video, wherein the current block includes at least one chroma block. The decoding circuit 201 is arranged to perform decoding of the current block by a prediction mode for intra chroma prediction of the chroma block. The prediction processing circuit 212 may include a motion compensation circuit (labeled by “MC”) 218, an intra prediction circuit (labeled by “IP”) 220, and an MPM list construction circuit (labeled by “MPM list construction”) 222. The proposed MPM-like syntax design is supported by the prediction processing circuit 212 (particularly, intra prediction circuit 220 of prediction processing circuit 212). As the present invention is focused on the proposed intra chroma MPM list design used for signalling of intra chroma prediction mode and a person skilled in the art should readily understand details of other circuit components included in the video decoder 200, further description of principles of other circuit components included in the video decoder 200 is omitted here for brevity.

The prediction processing circuit 212 performs an intra chroma prediction method for determining a prediction mode of a chroma block. Functions of the decoder-side intra prediction circuit 220 and MPM list construction circuit 222 are similar/identical to that of the encoder-side intra prediction circuit 130 and MPM list construction circuit 132. The MPM list construction circuit 222 is arranged to construct an ordered MPM list of one or more intra chroma MPM candidates (called “intra chroma MPM list L MPM” hereinafter) for a chroma block (e.g., a Cr block or a Cb block) included in a coding unit, where the intra chroma MPM list L_MPM constructed by the decoder-side MPM list construction circuit 222 is the same as that constructed by the encoder-side MPM list construction circuit 132. The intra prediction circuit 220 is arranged to determine a prediction mode of the chroma block, and generate an intra predictor P_CB/CR of each chroma sample included in the chroma block according to the prediction mode of the chroma block. In one embodiment, the proposed intra chroma MPM list design can be applied to all intra chroma modes or a subset of all intra chroma modes. That is, the intra chroma MPM list L_MPM can include all intra chroma modes or a subset of all intra chroma modes. In another embodiment, the proposed intra chroma MPM list design can be applied to all CCP modes or a subset of all CCP modes. That is, the intra chroma MPM list L_MPM can include all CCP modes (e.g., MMLM, GLM, CCCM, GL-CCCM, NoSubCCCM, CCCM-MDF, BVG-CCCM, and CCMerge) or a subset of all CCP modes. In yet another embodiment, only a fixed number of prediction modes can be put into the intra chroma MPM list L_MPM. That is, a size of the intra chroma MPM list L_MPM can be set by a pre-defined value.

In some embodiments of the present invention, before the prediction mode of the chroma block is determined by the intra prediction circuit 220, the entropy decoding circuit 204 parses syntax elements (which are indicative of information of the prediction mode selected at the video encoder 100) from the encoded video bitstream, and informs the intra prediction circuit 220 of the signalled syntax elements. In one embodiment, the syntax elements parsed from the encoded video bitstream may include an intra_chroma_mpm_flag that is signalled to indicate whether the prediction mode is included in the intra chroma MPM list L_MPM. In one embodiment, if the intra_chroma_mpm_flag is true (e.g., intra_chroma_mpm_flag=1), the syntax elements parsed from the encoded video bitstream may include an intra_chroma_mpm_index that is signalled to indicate selection of the prediction mode (which is included in the intra chroma MPM list L_MPM). In one embodiment, if the intra_chroma_mpm_flag is false (e.g., intra_chroma_mpm_flag=0), the syntax elements parsed from the encoded video bitstream may include a remaining mode index that is signalled to indicate selection of the prediction mode (which is not included in the intra chroma MPM list L MPM).

Regarding construction of the intra chroma MPM list L_MPM, it may employ a manner similar to that employed by construction of an intra luma MPM list. Hence, the prediction mode of a preciously coded block (i.e., a precious chroma block that is decoded before the current chroma block) at the neighboring region of the current chroma block can be added to the intra chroma MPM list L_MPM. In one embodiment, a prediction mode of one previously coded block at an above pre-defined position and a prediction mode of another previously coded block at a left pre-defined position will be checked and then put into the intra chroma MPM list L_MPM. In another embodiment, prediction modes of multiple previously coded blocks at neighboring pre-defined positions will be checked and then put into the intra chroma MPM list L_MPM. In another embodiment, prediction modes of multiple previously coded blocks at non-adjacent pre-defined positions will be checked and then put into the intra chroma MPM list L_MPM.

In addition to inserting a first prediction mode P1 to the intra chroma MPM list L_MPM, the MPM list construction circuit 222 may further insert a second prediction mode P2 to the intra chroma MPM list L_MPM according to the first prediction mode P1 already included in the intra chroma MPM list L_MPM. For example, the MPM list construction circuit 222 may refer to a similarity criterion to check similarity between the first prediction mode P1 and the second prediction mode P2. In one embodiment, only if a prediction mode is similar to the other prediction mode already in the intra chroma MPM list L_MPM, it can be added to the intra chroma MPM list L_MPM. Hence, when the first prediction mode P1 and the second prediction mode P2 are similar modes that meet the similarity criterion, the MPM list construction circuit 222 further adds the second prediction mode P2 (which is similar to the first prediction mode P1) to the intra chroma MPM list L_MPM. In another embodiment, if a prediction mode is similar to the other prediction mode already in the intra chroma MPM list L_MPM, it cannot be added to the intra chroma MPM list L_MPM for increasing the mode diversity of the intra chroma MPM list L_MPM. Hence, when the first prediction mode P1 and the second prediction mode P2 are not similar modes that meet the similarity criterion, the MPM list construction circuit 222 further adds the second prediction mode P2 (which is not similar to the first prediction mode P1) to the intra chroma MPM list L_MPM.

As mentioned above, the similarity criterion is checked to determine whether a prediction mode is a similar mode. In one embodiment, the similarity criterion is defined by two prediction modes using the same template region for deriving their parameters. For example, CCLM_L and CCCM_L may be regarded as similar modes due to using the left template for deriving their model parameters. In another embodiment, the similarity criterion is defined by two prediction modes using the same cross-component model. For example, CCCM_L and CCCM_T may be regarded as similar modes due to having the same model type. In another embodiment, the similarity criterion is defined by two prediction modes using input samples obtained from the same domain (e.g., downsampled luma domain, non-downsampled luma domain, or gradient domain). In another embodiment, the similarity criterion is defined by a combination of above-mentioned rules.

Consider a case where the MPM list construction circuit 222 needs to add prediction modes and their similar prediction modes to the intra chroma MPM list L_MPM. In one embodiment, prediction modes of all neighboring coded blocks can be added to the intra chroma MPM list L_MPM first, and similar prediction modes of all neighboring coded blocks can be added to the intra chroma MPM list L_MPM later. For example, in addition to inserting a first prediction mode P1 and a third prediction mode P3 to the intra chroma MPM list L_MPM, the MPM list construction circuit 222 may further insert a second prediction mode P2 and a fourth prediction mode P4 to the intra chroma MPM list L_MPM according to the first prediction mode P1 and the third prediction mode P3 already included in the intra chroma MPM list L_MPM, where the first prediction mode P1 and the second prediction mode P2 are similar modes that meet the similarity criterion, the third prediction mode P3 and the fourth prediction mode P4 are similar modes that meet the similarity criterion, and an order of any of the first prediction mode P1 and the third prediction mode P3 in the intra chroma MPM list is higher than an order of any of the second prediction mode P2 and the fourth prediction mode P4 in the intra chroma MPM list L_MPM. Assuming that the first prediction mode P1 is Left, the third prediction mode is Above, the second prediction mode is Left_similar, and the fourth prediction mode is Above_similar, the prediction modes in the intra chroma MPM list L_MPM may have an order of Left→Above→Left_similar→Above_similar.

In another embodiment, after adding one prediction mode of certain neighboring coded block into the intra chroma MPM list L_MPM, the MPM list construction circuit 222 adds one similar prediction to the intra chroma MPM list L_MPM. For example, in addition to inserting a first prediction mode P1 and a third prediction mode P3 to the intra chroma MPM list L_MPM, the MPM list construction circuit 222 may further insert a second prediction mode P2 and a fourth prediction mode P4 to the intra chroma MPM list L_MPM according to the first prediction mode P1 and the third prediction mode P3 already included in the intra chroma MPM list L_MPM, where the first prediction mode P1 and the second prediction mode P2 are similar modes that meet the similarity criterion, the third prediction mode P3 and the fourth prediction mode P4 are similar modes that meet the similarity criterion, and an order of any of the first prediction mode P1 and the second prediction mode P2 in the intra chroma MPM list L_MPM is higher than an order of any of the third prediction mode P3 and the fourth prediction mode P4 in the intra chroma MPM list L_MPM. Assuming that the first prediction mode P1 is Left, the third prediction mode is Above, the second prediction mode is Left_similar, and the fourth prediction mode is Above_similar, the prediction modes in the intra chroma MPM list L_MPM may have an order of Left→Left_similar→Above→Above_similar.

The MPM list construction circuit 222 may construct the intra chroma MPM list L_MPM by adding prediction modes to the intra chroma MPM list L_MPM according to an inserting order. In one embodiment, the MPM list construction circuit 222 sets the inserting order of prediction modes in the intra chroma MPM list L_MPM by a pre-defined inserting order. In another embodiment, the MPM list construction circuit 222 sets the inserting order of prediction modes in the intra chroma MPM list L_MPM according to a block shape of the chroma block. For example, if the block height is larger than the block width, the prediction mode from the left side is added first, and the prediction mode from the above side is added later. For another example, if the block width is larger than the block height, the prediction mode from the above side is added first, and the prediction mode from the left side is added later. In another embodiment, the MPM list construction circuit 222 sets the inserting order of prediction modes in the intra chroma MPM list L_MPM according to prediction mode priority, where a more powerful prediction mode is added first, and a less powerful prediction mode is added later. For example, the CCCM mode is always added first. For another example, the GLM mode is always added first.

In some embodiments of the present invention, a voting method similar to DIMD can be used in the MPM list construction. For example, the MPM list construction circuit 222 counts occurrence frequency of prediction mode candidates by checking prediction modes of multiple previously coded blocks at pre-defined positions, and adds selected prediction modes to the intra chroma MPM list L_MPM according to the occurrence frequency of the prediction mode candidates, wherein the selected prediction modes are several most frequently used prediction modes selected from the prediction mode candidates.

In some embodiments of the present invention, a template matching (TM) method similar to TIMD can be used in the MPM list construction. For example, the MPM list construction circuit 222 performs prediction on reference samples of a neighboring template according to each of prediction mode candidates, calculates a TM cost for each of the prediction mode candidates, and adds selected prediction modes to the intra chroma MPM list L_MPM according to TM costs of the prediction mode candidates, wherein the selected prediction modes are several prediction modes with smallest TM costs that are selected from the prediction mode candidates.

In another embodiment, the inserting order of prediction modes in the intra chroma MPM list L_MPM is set by a combination of above-mentioned methods.

As mentioned above, the entropy decoding circuit 204 may parse syntax elements from the encoded video bitstream, and inform the prediction processing circuit 212 of the syntax elements signalled from the video encoder 100. In one embodiment, a high-level syntax element can be parsed from the encoded video bitstream to enable the intra chroma MPM list design. For example, a high-level syntax element sps_chroma_mpm_flag (which is included in a sequence parameter set (SPS)) or pps_chroma_mpm_flag (which is included in a picture parameter set (PPS)) is parsed from the encoded video bitstream to indicate to apply the intra chroma prediction method with construction of the intra chroma MPM list. In another embodiment, a high-level syntax element can be parsed from the encoded video bitstream to indicate the size of the MPM list. For example, a high-level syntax element sps_chroma_mpm_size (which is included in SPS) or pps_chroma_mpm_size (which is included in PPS) is parsed from the encoded video bitstream to indicate the size of the intra chroma MPM list L_MPM.

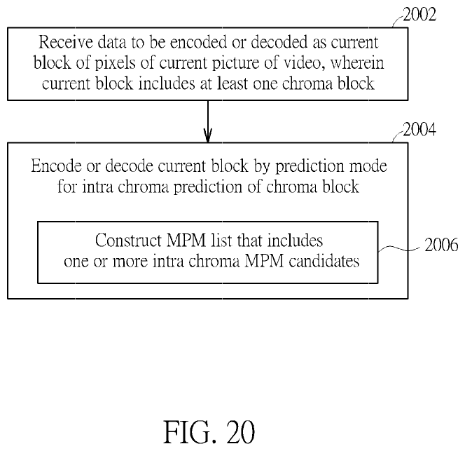

FIG. 20 is a flowchart illustrating a video coding method according to an embodiment of the present invention. The video coding method may be employed by the video encoder 100 shown in FIG. 18 for encoding of video data or the video decoder 200 shown in FIG. 19 for decoding of encoded video bitstream. At step 2002, data to be encoded or decoded is received as a current block of pixels of a current picture of a video, wherein the current block includes at least one chroma block. At step 2004, encoding or decoding of the current block is performed by using a prediction mode for intra chroma prediction of the chroma block. The step 2004 includes a sub-step 2006 that is performed for constructing an MPM list, wherein the MPM list includes one or more intra chroma MPM candidates. As a person skilled in the art can readily understand details of the video coding method after reading above paragraphs with reference to the accompanying drawings, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

1. A method for video coding, comprising:
receiving data to be encoded or decoded as a current block of pixels of a current picture of a video, wherein the current block comprises at least one chroma block; and
encoding or decoding the current block by a prediction mode for intra chroma prediction of the at least one chroma block, comprising:
constructing a most probable mode (MPM) list, wherein the MPM list comprises one or more intra chroma MPM candidates.

2. The method of claim 1, further comprising:
signalling or parsing a flag that indicates whether the prediction mode is included in the MPM list.

3. The method of claim 1, further comprising:
in response to the prediction mode being included in the MPM list, signalling or parsing an MPM index that indicates selection of the prediction mode.

4. The method of claim 1, further comprising:
in response to the prediction mode being not included in the MPM list, signalling or parsing a remaining mode index that indicates selection of the prediction mode.

5. The method of claim 1, wherein the MPM list includes all intra chroma modes or a subset of all intra chroma modes.

6. The method of claim 1, wherein the MPM list includes all cross-component prediction (CCP) modes or a subset of all CCP modes.

7. The method of claim 1, wherein a size of the MPM list is a pre-defined value.

8. The method of claim 1, wherein constructing the MPM list comprises:
checking a prediction mode of one previously coded block at an above pre-defined position; and
checking a prediction mode of another previously coded block at a left pre-defined position.

9. The method of claim 1, wherein constructing the MPM list comprises:
checking prediction modes of multiple previously coded blocks at neighboring pre-defined positions.

10. The method of claim 9, wherein constructing the MPM list further comprises:
checking prediction modes of multiple previously coded blocks at non-adjacent pre-defined positions.

11-22. (canceled)

23. The method of claim 1, wherein constructing the MPM list comprises:
counting occurrence frequency of prediction mode candidates by checking prediction modes of multiple previously coded blocks at pre-defined positions; and
adding selected prediction modes to the MPM list according to the occurrence frequency of the prediction mode candidates, wherein the selected prediction modes are most frequently used prediction modes selected from the prediction mode candidates.

24. The method of claim 1, wherein constructing the MPM list comprises:
performing prediction on reference samples of a neighboring template according to each of prediction mode candidates, and calculating a template matching (TM) cost for each of the prediction mode candidates; and
adding selected prediction modes to the MPM list according to TM costs of the prediction mode candidates, wherein the selected prediction modes are prediction modes with smallest TM costs that are selected from the prediction mode candidates.

25. The method of claim 1, further comprising:
signalling or parsing a first syntax element that indicates to apply the intra chroma prediction method with construction of the MPM list, wherein the first syntax element is included in a sequence parameter set (SPS) or a picture parameter set (PPS); or
signalling or parsing a second syntax element that indicates a size of the MPM list, wherein the second syntax element is included in the SPS or the PPS.

26. A video encoder, comprising:
a video data memory, arranged to receive data to be encoded as a current block of pixels of a current picture of a video, wherein the current block comprises at least one chroma block; and
an encoding circuit, arranged to perform encoding of the current block by a prediction mode for intra chroma prediction of the at least one chroma block, wherein the encoding circuit comprises:
a most probable mode (MPM) list construction circuit, arranged to construct an MPM list, wherein the MPM list comprises one or more intra chroma MPM candidates.

27. A video decoder, comprising:
a video data memory, arranged to receive data to be decoded as a current block of pixels of a current picture of a video, wherein the current block comprises at least one chroma block; and
a decoding circuit, arranged to perform decoding of the current block by a prediction mode for intra chroma prediction of the at least one chroma block, wherein the decoding circuit comprises:
a most probable mode (MPM) list construction circuit, arranged to construct an MPM list, wherein the MPM list comprises one or more intra chroma MPM candidates.
